(19) United States
(12) Patent Application Publication
(10) Pub. No.: US 2005/0101265 A1
(43) Pub. Date: May 12, 2005

(54) Radio frequency pulse generating apparatus

(76) Inventors: Mladen Marko Kekez, Ottawa (CA); Daniel David Kekez, Ottawa (CA)

Correspondence Address: William A. Blake;Jones, Tullar & Cooper, P.C., Eads Station, P.O. Box 2266, Arlington, VA, 22202, US

(21) Appl. No.: 10/702,036

(22) Filed: Nov. 6, 2003

(30) Foreign Application Priority Data
Oct. 28, 2003 (CA) 2,447,187

(51) Int. Cl. H04B 1/02

(52) U.S. Cl. 455/91

(57) ABSTRACT

A device for generating and radiating radio frequencies. The device includes a transmission line, a source, and a means for applying a voltage impulse to the transmission line from a low impedance source. A quarter-wave trap is added between the source and the transmission line to suppress the onset of a parasitic radiating mode. The quarter-wave trap also acts as an antenna to transmit the energy to the surrounding environment from the transmission line, which is behaving as an oscillatory circuit. The low impedance source is an electrically driven impulse generator. As a further modification, a second antenna can be attached to the free end of the transmission line to enable lower frequencies to be transmitted.

### BACKGROUND OF THE INVENTION

1. Field of the Invention

The invention relates to apparatus using delay lines to generate high power radio frequency (RF) pulses with high energy content in a single pulse of length between hundreds of nanoseconds to a few microseconds. High power is defined to be greater than 1 GW and high energy content is considered to be greater than 100 J.

2. Background Information

Attempts to create a device for generating high voltage pulses of short duration have resulted in several patents. One of the first patents on this topic, issued on Jun. 5, 1951 to R. L. Alty as U.S. Pat. No. 2,555,305, teaches the use of a transmitter as a load, driven by a pulse generating circuit consisting of an inductor, a capacitor and a switch. Several other patents have issued since Alty's, with modifications on his basic idea. One such patent is U.S. Pat. No. 3,579,111 issued to Lexington et al on May 18, 1971. This more recent patent uses a charging inductor connected through a charging switch to a source of direct current energy. The capacitor of an RF tank circuit cooperates with the charging inductor to achieve resonance. A power switch allows the charged tank circuit to oscillate at its natural frequency through a load connected in series. U.S. Pat. No. 4,491,842 issued on Jan. 1, 1985 to Gripshover et al shows yet another approach to generating high peak power, broadband radio frequency pulses. In this case, the generator is constructed with looped pairs of coaxial cables connected by spark gap switches. Square wave pulses are produced at a high pulse repetition frequency. An antenna is provided as a matched impedance load, connected by each half of the looped coaxial cables.

U.S. Pat. No. 4,482,816 issued on Nov. 13, 1984 to Richardson et al takes a different approach and creates a high current, low voltage pulse. Several pulse forming networks are connected in parallel with a common double-sided printed circuit board and are discharged through thyristors. The high current, low voltage pulse is fed to a magnetron via a transformer and a radar transmitter is driven by the combined outputs of the pulse forming networks.

A typical RF transmission system consists of a transmitter and an antenna. The transmitter may be viewed as a closed oscillatory circuit and the antenna is an open oscillatory circuit. Usually the transmitter and antenna must be connected via a transmission line, which becomes an extension of the closed oscillatory circuit. For maximum energy transfer, the output impedance of the transmitter must match the input impedance of the transmission line. Accordingly, the antenna and transmission line must also be matched—the impedance seen looking from the antenna terminals toward the transmission line must equal the conjugate of the antenna's impedance (the resistive components must be equal and the reactive components must be equal in amplitude, but opposite in sign). The radiations emitted from the oscillatory circuit always converge toward the lower frequencies because the resistive losses are smaller at those frequencies.

The use of delay lines or transmission lines for generating high voltage pulses is known from U.S. Pat. No. 5,138,270 issued to Nakata on Aug. 11, 1992. The prior art described in the patent connects a pulse forming network to a transmission line via a switching device. The transmission line is then connected to a load. The patent itself uses capacitors and inductors to represent characteristics of the circuit and replaces the pulse forming network with a Blumlein charge circuit. A preferred embodiment uses two parallel coaxial cables for the Blumlein charge circuit.

An impulse generator can also be used as a transmitter. The charge in the impulse generator can be viewed as a simple capacitor, transmission line and switch or as a capacitor, inductor and switch. An example of an impulse generator, a Marx generator, operates on the principle that a short, high voltage pulse can be created by charging a stack of parallel capacitors to a low voltage and then switching them in series. Other electrical pulsed power supplies that can be used include a Blumlein generator, an LC bank, an inductive storage/plasma opening switch or a Tesla transformer/storage transmission line. An electrical pulsed power supply can facilitate high operation of the RF radiating device (up to 1000 pulses/sec). Ten percent of the energy stored in the generator is converted into RF emissions for compact systems. For larger, electrically driven systems, the emitted RF radiations can exceed 1 GW with the efficiency of conversion exceeding 10%.

The modulation of energy from an oscillatory circuit is achieved with suitable antennas. If the antennas are absent, the RF energy available in the oscillatory circuit is wasted. The antenna can have any form, however not all forms are optimal for all frequencies. Optimization of the antenna will result in a higher efficiency and a better device.

A parasitic radiating circuit occurs when a radiating element that is not connected to the antenna affects the radiation pattern or impedance of the antenna. To reduce or eliminate the current in the parasitic radiating circuit, a quarter-wave trap can be provided. U.S. Pat. No. 4,542,358 issued on Sep. 17, 1985 to Boby uses a quarter-wave trap to protect a coaxial cable from high-powered, low frequency parasitic pulses. The quarter-wave trap consists of two microstrips arranged in parallel, separated by a dielectric substrate. The microstrips have a length that is a multiple of a quarter of the operational wavelength. It is important to reduce or eliminate parasitic currents in devices generating high voltage radio frequency pulses of short duration.

### SUMMARY OF THE INVENTION

The invention relates to a device for generating and transmitting radio frequencies. The device comprises a transmission line, a low impedance source, and means for applying a voltage impulse from the source to the transmission line. The transmission line becomes an oscillatory circuit and transfers the RF energy from the circuit to the surrounding environment via an antenna. A quarter-wave trap/antenna is also added to suppress the onset of the parasitic radiating mode.

The transmission line or delay line is broken into two or more smaller transmission lines to improve the control of the oscillations. Connected in series, short-circuited at one end and attached to the electrically driven impulse generator at the other end, the transmission lines transport energy from the impulse generator to the antenna. When a coaxial line is used for the transmission lines, the outer surface of the generator becomes part of a parasitic radiating circuit. A quarter-wave trap remedies this situation and reduces the current of the parasitic circuit by introducing a large impedance. Additionally, the quarter-wave trap behaves as a second antenna and enables pulses of a lower frequency to be generated.

The present invention relates to a Radio Frequency (RF) pulse generating device comprising a main delay line, a low impedance electrically driven impulse generator, and a quarter-wave trap between the impulse generator and the main delay line. The main delay line is connected to the electrically driven impulse generator at one end and short-circuited at the opposite end. The output impedance of the impulse generator is small compared to the characteristic impedance of the main delay line, which becomes an oscillatory circuit. In another embodiment, an additional antenna can be connected in place of the short circuit at the end of the main delay line, opposing the impulse generator.

### BRIEF DESCRIPTION OF THE DRAWINGS

FIG. 1 is a schematic view of an RF generator according to the invention.

FIG. 2 shows computer simulations of the circuit of FIG. 1 for the following conditions: C=83.3 nF, V=200 kV, Z_{D}=100 Ω and T₁=T₂=3 ns. Frames A, B and C are voltage, current and an FFT of the available power, respectively.

FIG. 3 is a schematic view of an RF generator with an antenna and quarter-wave trap according to the invention.

FIG. 4, Frames A and B show the available power and its FFT respectively for computer simulations of the circuit of FIG. 3. Conditions are as follows: C=83.3 nF, V=200 kV, ZD=100 ohm ZG=10 Ω, T_{G}=5 ns, R_{G}+R_{A}=6 Ω, R_{G}<<R_{A} and T₁=T₂=3 ns. Frames C and D show computer simulations of the available power and its FFT respectively, with the capacitive load of the antenna, C, set to 50 pF and attached between points 50 and 52, and with the delay line of the generator absent for the same conditions as Frames A and B.

### DESCRIPTION OF THE PREFERRED EMBODIMENTS

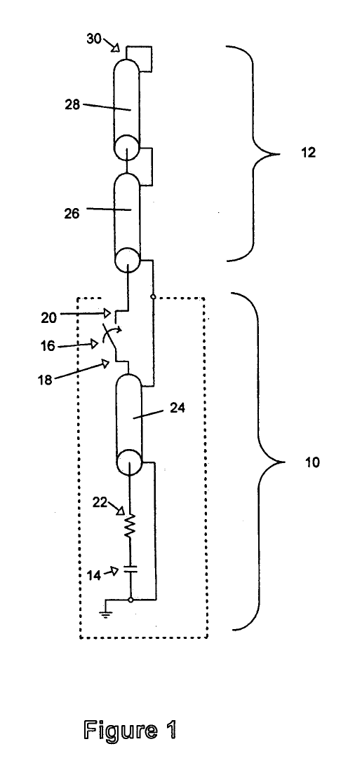

FIG. 1 shows the apparatus of the present invention, which comprises two main parts, an impulse generator 10 and a main delay line 12. The impulse generator is illustrated by its equivalent circuit of capacitor, C_{G}, 14 charged to voltage V and by a closing switch 16 placed between points 18 and 20. The output impedance of the generator, R_{G} 22, limits the amount of current the generator delivers when it is short-circuited and must be considerably smaller than the characteristic impedance of the main delay line. The internal transmission line T_{G} 24 represents the physical dimension of the generator. Typically R_{G} is small (i.e. R_{G}<10 Ω) and the transit time T_{G} is short. Alternatively, in another embodiment, a compact Marx generator is used for the impulse generator.

The main delay line, T_{D}, 12 is divided into 2 parts: T_{D}=T₁+T₂. The first delay line, T₁, 26 is attached to the switch 16 of the generator 10 while the second delay line, T₂, 28 is short-circuited at 30 at the far end. By varying T₁ 26 with respect to T₂ 28, the distribution of energy along the delay line is controlled. A large variety of delay line configurations can be employed, such as a thin wire placed next to a cylinder, two wires standing vertically with respect to the ground, a combination of multi-parallel wire structures above the ground or a single wire parallel to the ground.

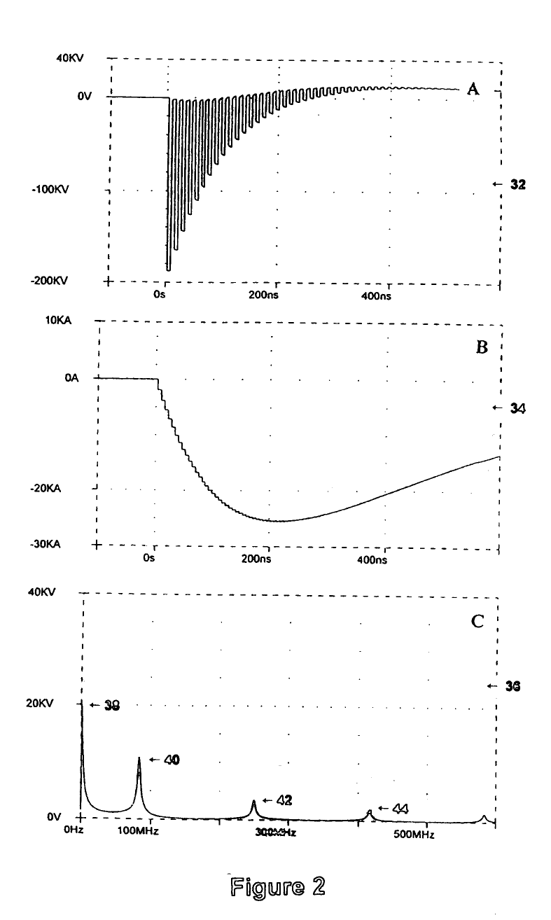

When the switch is closed, the energy stored in C_{G} 14 is transferred to the main delay line, T_{D} 12. The value of the output impedance of the generator, R_{G} 22 determines how much power the delay line will receive. As R_{G} decreases, the power transferred to the delay line increases, leading to the ideal case for maximum power transfer occurring with an R_{G} of zero. The energy transferred into the main delay line reflects from both ends of the delay line, creating an oscillatory voltage waveform, shown in FIG. 2, Frame A, 32. Frame B, 34, shows that the current waveform is relatively smooth. Frame 3, 36, shows the results of a Fast Fourier Transform (FFT) of the voltage waveform. Two basic frequencies are produced by the circuit of FIG. 1, f₁ 38 at 1 MHz and f₂ 40 at 83.33 MHz with two harmonics 42 and 44. The frequency of interest, f₂, is directly related to the time delay, T_{D} through the following equation;

$${f}_{2} = \frac{1}{2 {T}_{D}} \qquad ( 1 )$$

Thus, for a T_{D} of 6 ns, f₂ is 83.33 MHz.

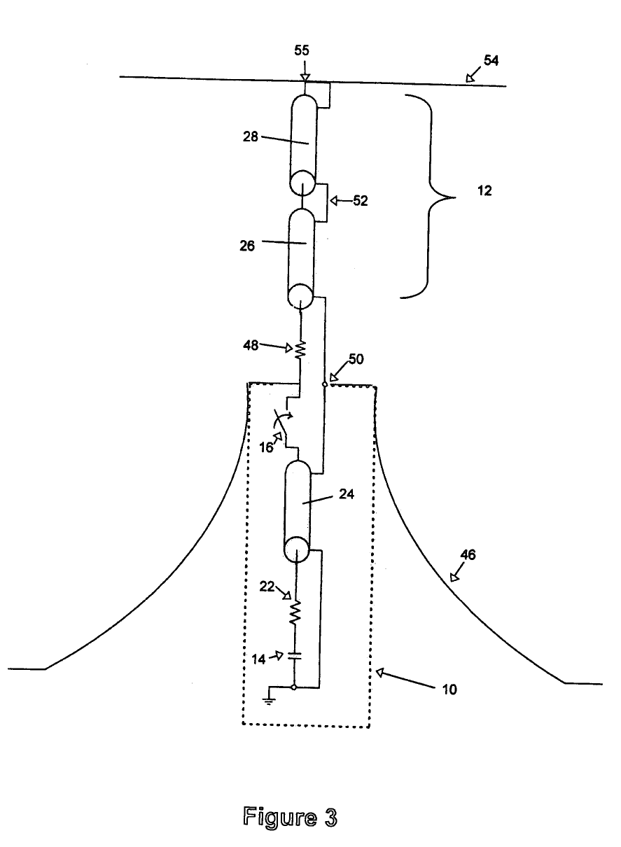

To extract the energy from the main delay line, a quarter-wave trap 46 is introduced, as shown in FIG. 3. The trap ensures that the outer surface of the impulse generator does not become part of the parasitic radiating circuit. Without this trap, the RF device works poorly, if at all. The trap 46 also functions as a radiating antenna, capable of transmitting the energy available in the delay line 12 to the surroundings. Since the oscillatory circuit sees the resistive and reactive components of the trap, the frequency is lowered and the total energy stored in the oscillatory system is enhanced, thus the antenna/trap permits lower frequencies to be transmitted than would otherwise be possible. The size of the quarter-wave trap determines the value of the lowest frequency that is extracted from the system.

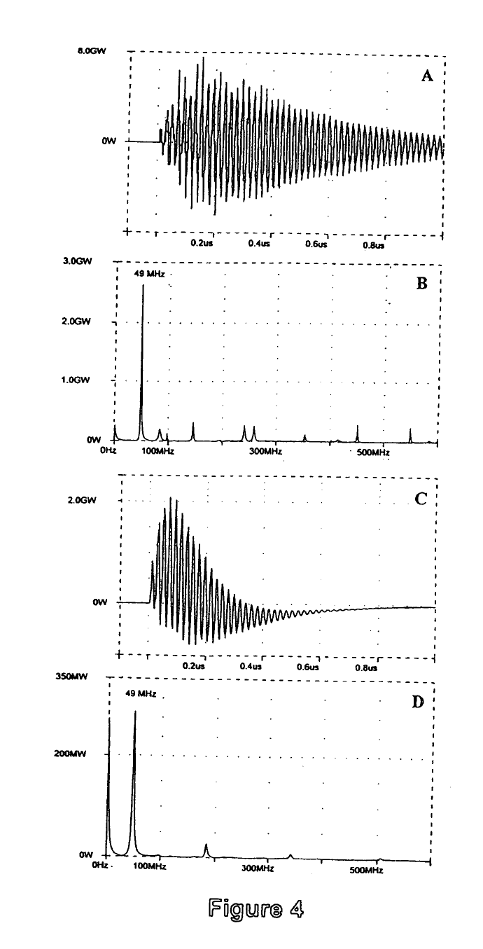

In one embodiment, the antenna/trap is represented as a load, R_{A} 48. The trap enhances the available power by an order of magnitude since the low-impedance generator delay line acts as an additional reservoir of energy that feeds the energy from the generator into the oscillatory circuit. The main frequency of oscillation also decreases from 83.33 MHz to 49 MHz, as shown in the FFT results of FIG. 4, Frame B.

In one embodiment, the delay line of the generator is removed and a capacitive load C attached between points 50 and 52 in FIG. 3. This added capacitance behaves as a reservoir of energy that enhances the value of the total power available in the oscillatory circuit. FIG. 4, Frame D shows the main frequency of oscillation also decreases to 49 MHz when the capacitor C is added.

The device can additionally be modified by adding an antenna 54 at the free end of the main delay line, at point 55, shown in FIG. 3. Due to capacitive coupling between the antenna and the quarter-wave trap, this system is better able to radiate lower frequencies. The extra antenna also boosts the total emitted power by an order of magnitude.

The foregoing has described the present invention. It will be understood that a person skilled in the art can deviate from the exact structure as described herein without departing from the spirit of the invention.

1. A Radio Frequency (RF) pulse generating device comprising
a main delay line,
a low impedance electrically driven impulse generator, and
a quarter-wave trap between the impulse generator and the main delay line,
the main delay line being connected to the electrically driven impulse generator at one end and being short-circuited at an opposite end, the output impedance of the impulse generator being small compared to the characteristic impedance of the main delay line, whereby the main delay line becomes an oscillatory circuit.

2. A Radio Frequency (RF) pulse generating device comprising
a main delay line,
a low impedance electrically driven impulse generator,
an antenna, and
a quarter-wave trap between the impulse generator and the main delay line,
the main delay line being connected to the electrically driven impulse generator at one end and the antenna being connected at an opposite end of the main delay line, the output impedance of the impulse generator being small compared to the characteristic impedance of the main delay line, whereby the main delay line becomes an oscillatory circuit.

3. The device of claim 1 wherein the main delay line is comprised of two or more smaller delay lines connected in series.

4. The device of claim 1 wherein a capacitor is connected parallel to the main delay line or one of the smaller delay lines.

5. The device of claim 1 wherein the impulse generator is a capacitor connected in series with an internal delay line and a switch.

6. The device of claim 1 wherein a resistor represents the quarter-wave trap between the impulse generator and the main delay line.

7. The device of claim 2 wherein the main delay line is comprised of two or more smaller delay lines connected in series.

8. The device of claim 2 wherein a capacitor is connected parallel to the main delay line or one of the smaller delay lines.

9. The device of claim 2 wherein the impulse generator is a capacitor connected in series with an internal delay line and a switch.

10. The device of claim 2 wherein a resistor represents the quarter-wave trap between the impulse generator and the main delay line.
